(19) United States
(12) Patent Application Publication
(10) Pub. No.: US 2020/0204396 A1
(43) Pub. Date: Jun. 25, 2020

(54) ON-BOARD COMMUNICATION SYSTEM, ON-BOARD RELAY APPARATUS, AND MESSAGE RELAY METHOD

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka-Shi, Osaka (JP)

(72) Inventor: Naoto Kobayashi, Yokkaichi, Mie (JP)

(21) Appl. No.: 16/612,840

(22) PCT Filed: Apr. 25, 2018
(86) PCT No.: PCT/JP2018/016698

§ 371 Date: Nov. 12, 2019

(30) Foreign Application Priority Data
May 16, 2017 (JP) 2017-097562

(51) Int. Cl. H04L 12/40; B60R 16/023

(52) U.S. Cl. CPC H04L 12/40006; H04L 2012/40273; H04L 2012/40215; B60R 16/023

(57) ABSTRACT

An on-board communication system includes: an on-board relay apparatus configured to relay message transmission and reception between a plurality of bus communication lines; a plurality of first on-board communication apparatuses is connected to one of the plurality of communication lines; and a second on-board communication apparatus is connected to at least two of the plurality of communication lines. The second on-board communication apparatus transmits, if a specific message is received through one of the connected communication lines, the message through another communication line. The on-board relay apparatus determines whether or not the specific message received through one of the connected communication lines satisfies a predetermined discard condition. The on-board relay apparatus does not relay the specific message if it is determined that the discard condition is satisfied, and transmits the specific message from another one of the communication lines if it is determined that the discard condition is not satisfied.

### CROSS-REFERENCE TO RELATED APPLICATIONS

This application is the U.S. national stage of PCT/JP2018/016698 filed on Apr. 25, 2018, which claims priority of Japanese Patent Application No. JP 2017-097562 filed on May 16, 2017, the contents of which are incorporated herein.

### TECHNICAL FIELD

The present disclosure relates to an on-board communication system, an on-board relay apparatus, and a message relay method for relaying messages between a plurality of communication lines mounted in a vehicle.

### BACKGROUND

A large number of apparatuses such as ECUs (Electronic Control Units) are mounted in a vehicle, these apparatuses are connected via communication lines, and operate in cooperation by exchanging messages by transmitting and receiving messages. Conventionally, the CAN (Controller Area Network) communication protocol has been widely adopted for communication in a vehicle. The CAN communication protocol employs a bus network configuration in which a plurality of communication apparatuses are connected to one communication line. In recent years, the number of apparatuses installed in a vehicle has increased, but the number of apparatuses that can be connected to the CAN bus has an upper limit. Accordingly, in many cases, a plurality of CAN buses are mounted in a vehicle, the plurality of CAN buses are connected to a relay apparatus such as a gateway, and the relay apparatus relays messages between the CAN buses.

Also, conventionally, a vehicle is provided with a function of diagnosing on-board apparatuses. The diagnostic apparatus provided at the dealer of the vehicle or the like collects information from on-board apparatuses, for example, by connecting the diagnostic apparatus to a specific connector provided in the vehicle. Then, based on the collected information, the diagnostic apparatus can diagnose, for example, whether there is a defect of the vehicle. At this time, the diagnostic apparatus may send a broadcast message requesting information collection to the network of the vehicle. When an on-board apparatus that has received the broadcast message transmits information to the diagnostic apparatus, information collection of the vehicle by the diagnostic apparatus is performed.

If the relay apparatus receives a broadcast message from the diagnostic apparatus, the relay apparatus transmits the broadcast message to all communication lines other than the one from which the broadcast message has been received, and relays the broadcast message to all communication apparatuses. In recent years, the network configuration in vehicles has become complicated, and in addition to the relay apparatus, communication apparatuses connected to a plurality of communication lines may be present in the vehicle. If there is a communication apparatus connected to a plurality of communication lines, a loop of communication paths may be formed between the communication apparatus and the relay apparatus. When such a communication path loop is present, if the communication apparatus connected to the plurality of communication lines relays a broadcast message, relaying of the broadcast message may continue repeatedly between the communication apparatus and the relay apparatus.

In JP 2017-5367A, a communication system is disclosed, which prevents a broadcast frame from circulating in a network configuration in which a plurality of Ethernet (registered trademark) switches are connected in a ring, if the Ethernet switches receive a broadcast frame, by comparing the transmission source MAC address included in the broadcast frame with the MAC address registered in their own MAC address table and determining whether to discard the broadcast frame.

However, the communication system disclosed in JP 2017-5367A is premised on a network configuration in which a plurality of Ethernet switches are connected in a ring shape. Accordingly, there is a problem that the communication system cannot be applied to the CAN communication protocol, which is a bus network configuration. Further, it is necessary to provide a function to determine whether or not to discard the broadcast frame in all of the plurality of Ethernet switches connected in a ring. Therefore, there is a problem that the cost increases as the scale of the network increases.

The present disclosure has been made in view of such circumstances, and an object of the present disclosure is to provide an on-board communication system, an on-board relay apparatus, and a message relay method capable of preventing repetition of a message in a bus network configuration.

### SUMMARY

An on-board communication system including: an on-board relay apparatus to which a plurality of bus communication lines mounted in a vehicle are connected, and that is configured to relay message transmission and reception between the plurality of communication lines; a plurality of first on-board communication apparatuses each connected to exactly one of the plurality of communication lines; and a second on-board communication apparatus connected to at least two of the plurality of communication lines, wherein the second on-board communication apparatus includes a specific message relay processing unit configured to, if a specific message is received through one of the connected communication lines, perform a processing of transmitting the specific message through another one of the communication lines, the on-board relay apparatus includes: a determination unit configured to determine whether the specific message received through one of the connected communication lines satisfies a predetermined discard condition; and a specific message relay processing unit configured to not relay the specific message if the determination unit determines that the specific message satisfies the discard condition, and to perform a processing of transmitting the specific message through another one of the communication lines if the determination unit determines that the specific message does not satisfy the discard condition.

Also, in the on-board communication system according to the present disclosure, the determination unit of the on-board relay apparatus may be configured to determine whether identification information included in a specific message previously transmitted by the specific message relay processing unit of the on-board relay apparatus matches identification information included in a specific message received through one of the communication lines, and the specific message relay processing unit may not relay the specific massage if the determination unit determines that the identification information matches.

Also, in the on-board communication system according to the present disclosure, the determination unit of the on-board relay apparatus may be configured to determine whether identification information included in a specific message previously transmitted by the specific message relay processing unit of the on-board relay apparatus matches identification information included in a specific message received through one of the communication lines, and determine whether the communication line through which the previous specific message whose identification information matches was received and the communication line through which the current specific message is received are different from each other, and the specific message relay processing unit may be configured to not relay the specific message if the determination unit determines that the identification information matches, and both communication lines are different from each other.

Also, in the on-board communication system according to the present disclosure, the on-board relay apparatus may include a storage unit configured to store identification information included in the relayed specific message, and a timer unit configured to measure an elapsed time from transmission of the specific message for each piece of identification information stored in the storage unit, wherein the determination unit of the on-board relay apparatus may determine whether the discard condition is satisfied for any specific message including the identification information whose elapsed time measured by the timer unit is within a predetermined time.

Also, in the on-board communication system according to the present disclosure, the plurality of communication lines may include a communication line to which a connector for attaching and detaching a diagnostic apparatus of the vehicle is connected, and the diagnostic apparatus connected to the connector may transmit the specific message to the communication line.

Also, in the on-board communication system according to the present disclosure, the plurality of first on-board communication apparatuses may include a wireless communication apparatus configured to perform wireless communication with the diagnostic apparatus of the vehicle, and the wireless communication apparatus may transmit the specific message that is received from the diagnostic apparatus by wireless communication to the communication lines of the vehicle.

Also, an on-board relay apparatus according to the present disclosure is an on-board relay apparatus to which a plurality of bus communication lines mounted in a vehicle are connectable, and that is configured to relay message transmission and reception between the plurality of communication lines, the on-board relay apparatus includes: a determination unit configured to determine whether a specific message received through one of the connected communication lines satisfies a predetermined discard condition; and a specific message relay processing unit configured to not relay the specific message if the determination unit determines that the specific message satisfies the discard condition, and to perform a processing of transmitting the specific message through another one of the communication lines if the determination unit determines that the specific message does not satisfy the discard condition.

Also, a message relay method according to the present disclosure is a message relay method in which an on-board relay apparatus to which a plurality of bus communication lines mounted in a vehicle are connected relays message transmission and reception between the plurality of communication lines, the message relay method comprising the steps of determining whether a specific message received through one of the connected communication lines satisfies a predetermined discard condition; not relaying the specific message if it is determined that the specific message satisfies the discard condition; and transmitting the specific message through another one of the connected communication lines if it is determined that the specific message does not satisfy the discard condition.

In the present disclosure, the on-board communication system adopts a bus network configuration in which the plurality of on-board communication apparatuses are connected to the same communication line (that is, a bus), connects the plurality communication lines provided in the vehicle to the on-board relay apparatus, and the on-board relay apparatus relays message transmission and reception between the communication lines. Also, the plurality of on-board communication apparatuses included in the on-board communication system includes the first on-board communication apparatus connected to one communication line, and the second on-board communication apparatus connected to at least two communication lines. If the second on-board communication apparatus receives a specific message through one communication line, the second on-board communication apparatus relays the specific message to other communication lines.

If the on-board relay apparatus to which the plurality of communication lines are connected receives a specific message through one communication line, the on-board relay apparatus determines whether the specific message satisfies a predetermined discard condition. If it is determined that the received specific message satisfies the discard condition, the on-board relay apparatus discards the specific message without relaying it. If it is determined that the received specific message does not satisfy the discard condition, the on-board relay apparatus relays the specific message.

In this manner, the second on-board communication apparatus can relay a specific message without performing the determination on the discard condition, and the on-board relay apparatus can prevent the relay of the specific message from being repeated.

Also, in the present disclosure, the on-board relay apparatus compares the identification information included in the specific message that was previously relayed with the identification information included in the specific message that was newly received, and makes a determination under the condition that the identification information matches each other. In this manner, the on-board relay apparatus can prevent relaying again a specific message that is likely to be the same as the specific message relayed previously.

Also, in the present disclosure, as mentioned above, the on-board relay apparatus makes a determination under the condition that the identification information matches each other, and the communication line through which a specific message was previously received and the communication line through which a specific message was received this time are different from each other. If a specific message having the same identification information is received through another communication line, this specific message is likely to be a specific message cyclically relayed by the second on-board communication apparatus. Accordingly, it is possible to prevent relaying such a specific message again.

Also, in the present disclosure, if the on-board relay apparatus relays a specific message, the on-board relay apparatus stores the identification information of the specific message, and also measures an elapsed time from transmission of the specific message for each piece of identification information. The on-board relay apparatus determines whether the identification information whose elapsed time is within the predetermined time satisfies the discard condition, and does not set the identification information, which has passed the predetermined time or more since the previous transmission, as the target of the determination as to whether or not the discard condition is satisfied. By providing such a time limit in the determination, for example, if a specific message is appropriately re-sent after a predetermined time has elapsed, it can be suppressed that the valid specific message is discarded.

Note, that the specific message is, for example, a broadcast message or a message related to the diagnosis of the vehicle. Such a message is highly likely to be relayed by the second on-board communication apparatus to which the plurality communication lines are connected. Accordingly, such a message may be relayed repeatedly by the on-board relay apparatus and the second on-board communication apparatus. Therefore, by determining these messages, as the specific messages, under the discard condition, it is possible to prevent the relay of the specific message from being repeated.

Note, that the specific message may also be a message other than a broadcast message and a message related to the diagnosis of the vehicle. The specific message may also be any message, as long as it may be relayed by the second on-board communication apparatus.

Also, in the present disclosure, the plurality of communication lines to be connected to the on-board relay apparatus include a communication line to which a connector for attaching and detaching the diagnostic apparatus of the vehicle is connected, and the diagnostic apparatus connected to the connector transmits a specific message. Alternatively, the first on-board communication apparatus includes a wireless communication apparatus that performs wireless communication with the diagnostic apparatus of the vehicle, and the wireless communication apparatus transmits a specific message received from the diagnostic apparatus to the communication lines in the vehicle. The on-board relay apparatus can prevent the specific message transmitted from such an external diagnostic apparatus from being repeatedly relayed in the network of the vehicle.

### Advantageous Effects of Disclosure

According to the present disclosure, repeated message relaying can be prevented in a bus network configuration, by adopting a configuration in which a specific message received by the on-board relay apparatus through one communication line is not relayed if the specific message satisfies the discard condition, and the specific message is transmitted through another communication line if the specific message does not satisfy the discard condition.

### BRIEF DESCRIPTION OF DRAWINGS

FIG. 1 is a schematic view showing the configuration of an on-board communication system according to the present embodiment.

FIG. 2 is a schematic view showing an example of the configuration of the on-board communication system in which there is no looping of diagnostic messages.

FIG. 3 is a block diagram showing the configuration of a gateway according to the present embodiment.

FIG. 4 is a block diagram showing the configuration of an ECU according to the present embodiment.

FIG. 5 is a block diagram showing the configuration of the ECU according to the present embodiment.

FIG. 6 is a schematic view showing an example of relay ID information stored in the storage unit and a relay flag.

FIG. 7 is a flowchart showing a procedure of the processing of relay and discard of a diagnostic message, which is performed by the gateway.

### DETAILED DESCRIPTION OF PREFERRED EMBODIMENTS

### System Configuration

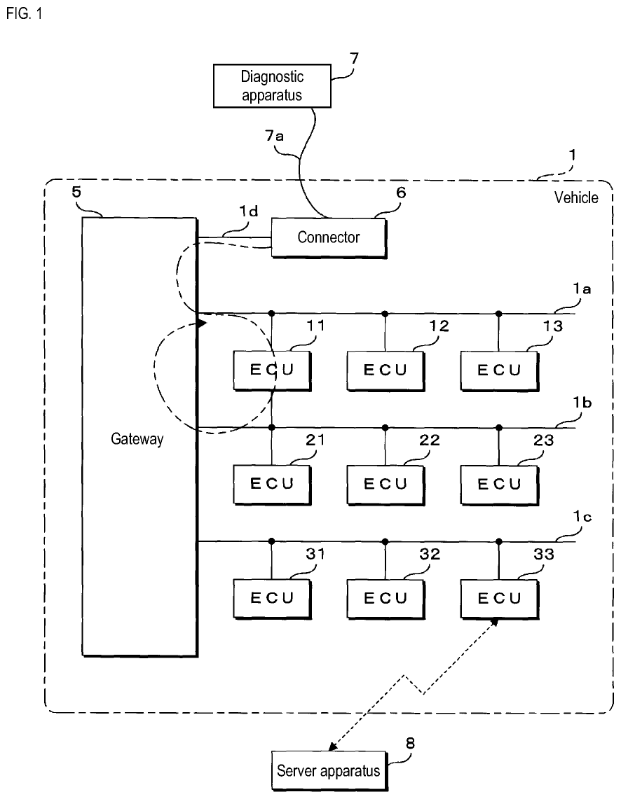

FIG. 1 is a schematic view showing the configuration of an on-board communication system according to the present embodiment. The on-board communication system according to the present embodiment is configured such that a plurality of ECUs 11 to 13, 21 to 23, and 31 to 33 mounted in a vehicle 1 transmit and receive messages via a plurality of communication lines 1a to 1c and a gateway 5 mounted in the vehicle 1. Specifically, the plurality of bus communication lines 1a to 1c are disposed at appropriate positions in the vehicle 1. These communication lines 1a to 1c are connected to the gateway 5, and the gateway 5 relays messages between the communication lines 1a to 1c. In the present embodiment, the ECUs 11 to 13 are connected to the communication line 1a, the ECU 11 and the ECUs 21 to 23 are connected to the communication line 1b, and the ECUs 31 to 33 are connected to the communication line 1c. In the present embodiment, the ECU 11 is connected to the two communication lines 1a and 1b, and can transmit and receive messages to the communication lines 1a and 1b.

Further, in the present embodiment, a connector 6 for detachably connecting a diagnostic apparatus 7 for diagnosing the vehicle 1 is disposed at a suitable position. The connector 6 is connected to the gateway 5 via the communication line 1d. The diagnostic apparatus 7 is, for example, an apparatus provided at a dealer, a maintenance factory, or the like of the vehicle 1, and is connected to the connector 6 of the vehicle 1 via a cable 7a. The diagnostic apparatus 7 connected to the connector 6 communicates with the ECUs 11 to 13, 21 to 23, and 31 to 33 of the vehicle 1 through the communication lines 1a to 1d and the gateway 5 to obtain various information in the vehicle 1, and diagnoses whether there is a defect or the like of the vehicle 1.

In the on-board communication system according to the present embodiment, the CAN communication protocol is adopted for communication between apparatuses. That is to say, the ECUs 11 to 13, 21 to 23, and 31 to 33 and the gateway 5 perform message transmission and reception according to the CAN communication protocol via the communication lines 1a to 1c. Furthermore, in the present embodiment, the diagnostic apparatus 7 also performs message transmission and reception according to the CAN communication protocol. Accordingly, the communication lines 1a to 1d are two-wire buses for transmitting and receiving differential signals, that is, so-called CAN buses. However, the on-board communication system may also be configured to communicate using a communication protocol other than CAN, such as LIN (Local Interconnect Network) or FlexRay, for example. Also, a configuration in which a plurality of communication protocols are mixed may also be adopted. In this case, for example, the gateway 5 may be configured to perform protocol conversion when relaying messages.

In the present embodiment, the ECU 33 has a function of performing wireless communication using, for example, a public mobile telephone communication network or a wireless LAN (Local Area Network). With this configuration, the ECU 33 can exchange messages with, for example, a server apparatus 8 installed outside the vehicle 1. The server apparatus 8 is an apparatus operated by, for example, a manufacturing company or a sales company of the vehicle 1. The server apparatus 8 communicates with the vehicle 1 at a predetermined timing or periodically, obtains various types of information in the vehicle 1, and diagnoses whether the vehicle 1 is defective or not. That is to say, the server apparatus 8 is a diagnostic apparatus that diagnoses the vehicle 1 remotely.

When diagnosing the vehicle 1, for example, an operator of the dealer of the vehicle 1 connects the diagnostic apparatus 7 to the connector 6 of the vehicle 1 via the cable 7a, and starts the operation of the diagnostic process. In this manner, the diagnostic apparatus 7 transmits, for example, a message requesting transmission of predetermined information to the apparatuses mounted in the vehicle 1 through the cable 7a to the vehicle 1. The message transmitted by the diagnostic apparatus 7 at this time is a so-called broadcast message that is transmitted simultaneously to all the apparatuses of the vehicle 1 to be diagnosed. In the present embodiment, a broadcast message for diagnosis transmitted by the diagnostic apparatus 7 is called a diagnostic message.

The diagnostic message transmitted by the diagnostic apparatus 7 is received by the gateway 5 through the cable 7a, the connector 6, and the communication line 1d. The gateway 5 that has received the diagnostic message relays the diagnostic message by transmitting the received diagnostic message to all communication lines 1a to 1c other than the communication line 1d, through which the diagnostic message has been received. The diagnostic message transmitted by the gateway 5 to the communication lines 1a to 1c is received by the ECUs 11 to 13, 21 to 23, and 31 to 33, which are each connected to one of the communication lines 1a to 1c.

The ECUs 11 to 13, 21 to 23, and 31 to 33 that have received the diagnostic message transmit information necessary for the diagnostic process of the diagnostic apparatus 7 to the communication lines 1a to 1c. When the gateway 5 has received the messages in response to the diagnostic message from the ECUs 11 to 13, 21 to 23, and 31 to 33, it relays the received messages to the communication line 1d, whereby the messages are transmitted to the diagnostic apparatus 7 connected to the connector 6. When the diagnostic apparatus 7 has received the messages from the vehicle 1, it accumulates the information included in the received messages, and diagnoses the presence or absence of an abnormality of the vehicle 1 based on the accumulated information.

Here, the on-board communication system according to the present embodiment includes the ECU 11, which is connected to the two communication lines 1a and 1b. The ECU 11 can transmit and receive messages to and from the communication lines 1a and 1b. Furthermore, when the ECU 11 according to the present embodiment receives a broadcast message through one of the communication lines 1a or 1b, the ECU 11 transmits the broadcast message through the other communication line and relays the broadcast message.

Accordingly, for example, if the ECU 11 receives a diagnostic message from the diagnostic apparatus 7 through the communication line 1a as mentioned above, since the diagnostic message is a broadcast message, the ECU 11 transmits the received diagnostic message through the communication line 1b. The diagnostic message relayed by the ECU 11 from the communication line 1a to the communication line 1b is received by the gateway 5 via the communication line 1b. If the gateway 5 receives a diagnostic message through the communication line 1b, the gateway 5 relays the diagnostic message to the other communication lines 1a, 1c, and 1d. The diagnostic message relayed by the gateway 5 is received by the ECU 11 via the communication line 1a, and the ECU 11 that has received the diagnostic message relays it to the communication line 1b.

Thus, when the gateway 5 and the ECU 11 relay a diagnostic message, a situation may occur in which the diagnostic message is continuously relayed in the on-board communication system. In FIG. 1, a path along which the relay of the diagnostic message is repeated is indicated by a double-dotted dashed arrow. Although not shown, the same situation occurs if the ECU 11 relays a diagnostic message from the communication line 1b to 1a. The repetition of such a diagnostic message (hereinafter referred to as “looping of a diagnostic message”) is attributable to the formation of a looped communication path by the gateway 5 and the ECU 11 in the on-board communication system.

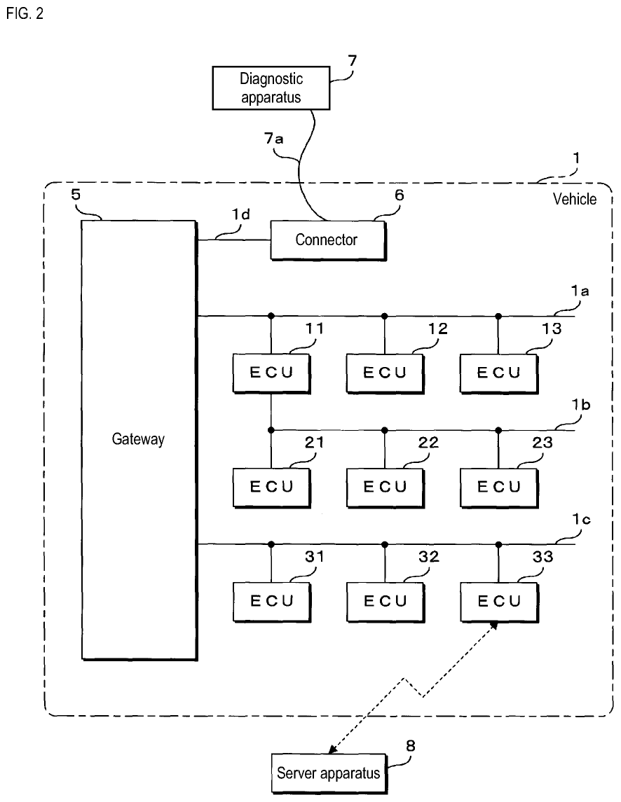

FIG. 2 is a schematic view showing an example of the configuration of an on-board communication system in which there is no looping of a diagnostic message. The on-board communication system shown in FIG. 2 is configured such that the communication line 1b is not connected to the gateway 5 in the on-board communication system shown in FIG. 1. The ECU 11 to which the two communication lines 1a and 1b are connected may be an ECU developed on the assumption that, for example, a tree-like network is configured. The ECU 11 operates as a higher-level ECU, and the ECUs 21 to 23 connected to the ECU 11 via the communication line 1b operate as lower-level ECUs. Therefore, if the ECU 11 receives a broadcast message through the communication line 1a, the ECU 11 has to relay the broadcast message to the lower-level ECUs 21 to 23. Accordingly, the ECU 11 is provided with the relay function as mentioned above.

However, for example, if the ECU 11 is generally mounted in vehicles 1 of various grades, destinations, and models, or if the system configuration is changed in the development process of the vehicle 1, a network configuration different from the assumption of the ECU 11 may be formed. In FIG. 2, for example, when the ECU 21 needs to communicate with the ECU 31, it takes time to acquire information if communication is performed via the ECU 11. Therefore, when the communication line 1b is directly connected to the gateway 5, and the ECU 21 and the ECU 31 communicate directly via the gateway 5, the system configuration shown in FIG. 1 can be obtained. Also in this case, when the ECU 11 relays a broadcast message, looping of a diagnostic message occurs as shown in FIG. 1. However, the reason why the loop network configuration is formed in the on-board communication system is not limited to this.

Note, that although the case where the diagnosis is performed by connecting the diagnostic apparatus 7 to the connector 6 of the vehicle 1 is described, there is no limitation to this. Also if the server apparatus 8 transmits a diagnostic message to the ECU 33 by wireless communication, looping of the diagnostic message may similarly occur. That is to say, similar looping of diagnostic messages is caused by the ECU 33 that has received a diagnostic message from the server apparatus 8 transmitting the diagnostic message to the communication line 1c, the gateway 5 that has received the diagnostic message through the communication line 1c relaying the diagnostic message to the communication lines 1a, 1b, and 1d, and the ECU 11 that has received the diagnostic message through the communication line 1a relaying the diagnostic message to the communication line 1b.

In the on-board communication system according to the present embodiment, the gateway 5 has a function of preventing the occurrence of such a diagnostic message loop. When the gateway 5 according to the present embodiment receives a diagnostic message (or a broadcast message) through one of the communication lines 1a to 1d, the gateway 5 determines whether the received diagnostic message is the same as or different from the diagnostic messages that itself has previously transmitted. If the received diagnostic message is the same as any of the previously transmitted diagnostic messages, the gateway 5 discards the diagnostic message without relaying it. If the received diagnostic message is different from the previously transmitted diagnostic messages, the gateway 5 relays the diagnostic message by transmitting it from the communication lines 1a to 1d other than the communication lines 1a to 1d that received the diagnostic message.

### Apparatus Configuration

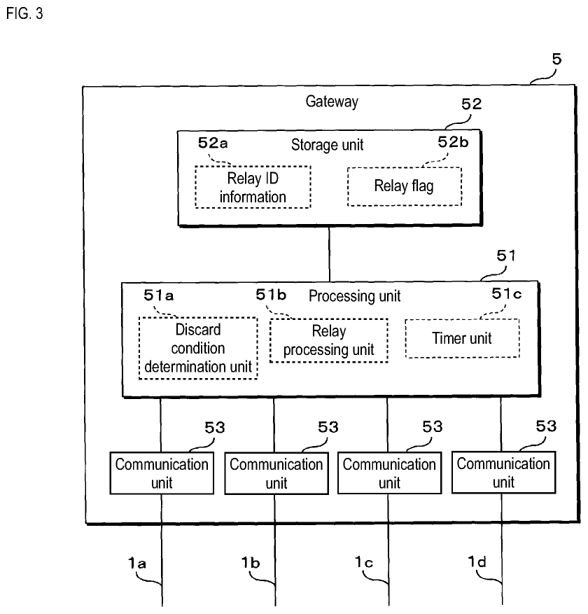

FIG. 3 is a block diagram showing the configuration of the gateway 5 according to the present embodiment. The gateway 5 according to the present embodiment includes a processing unit 51, a storage unit 52, and a plurality of communication units 53. The processing unit 51 is configured using, for example, an arithmetic processing unit such as a CPU (Central Processing Unit) or an MPU (Micro-Processing Unit), and performs various processes by reading out and executing a program stored in a ROM (Read Only Memory) or the like (not shown). In the present embodiment, the processing unit 51 performs relay processing of messages between communication lines 1a to 1d, and discard processing of unnecessary messages.

The storage unit 52 is configured using, for example, a memory element such as an SRAM (Static Random Access Memory) or a DRAM (Dynamic Random Access Memory). The storage unit 52 stores data and the like generated in the process of processing by the processing unit 51. In the present embodiment, the storage unit 52 stores relay ID information 52a, which is information related to an ID of a diagnostic message relayed by the relay processing of the processing unit 51, and a relay flag 52b indicating that a predetermined time has not yet elapsed from the relay of the diagnostic message.

The plurality of communication units 53 are each connected to one of the communication lines 1a to 1d, and transmit and receive messages via the connected communication lines 1a to 1d. The communication units 53 according to the present embodiment perform communication processing according to the CAN communication protocol. The communication units 53 transmit messages by converting a transmission message supplied from the processing unit 51 into an electric signal and outputting the electric signal to the communication lines 1a to 1d. Also, the communication units 53 receive messages by sampling and acquiring the potentials of the communication lines 1a to 1d, and provide the received message to the processing unit 51.

Further, the processing unit 51 of the gateway 5 according to the present embodiment executes the program stored in the ROM or the like, whereby a discard condition determination unit 51a, a relay processing unit 51b, a timer unit 51c, and the like are realized as software functional blocks. If a diagnostic message (or a broadcast message) is received by one of the communication units 53, the discard condition determination unit 51a determines whether the received diagnostic message satisfies a predetermined discard condition. Details of the discard condition used by the discard condition determination unit 51a for the determination will be described later.

By providing a message received by one of the communication units 53 to the other communication units 53, the relay processing unit 51b relays the message. By providing a diagnostic message for which it has been determined by the discard condition determination unit 51a that the discard condition is not satisfied to the communication units 53 other than the communication unit 53 that has received the diagnostic message, the relay processing unit 51b relays the diagnostic message. Note, that the relay process of normal messages (messages other than diagnostic messages and broadcast messages) by the gateway 5 is performed using the existing technology, so that its description is omitted.

The timer unit 51c, which is also referred to as a “timer”, measures the elapsed time of process. In the present embodiment, the timer unit 51c measures the elapsed time after relaying a diagnostic message by the gateway 5. Also, the timer unit 51c can measure an elapsed time individually for each ID attached to the diagnostic message, and thus can measure a plurality of elapsed times in parallel. The elapsed time measured by the timer unit 51c is used for determination by the discard condition determination unit 51a.

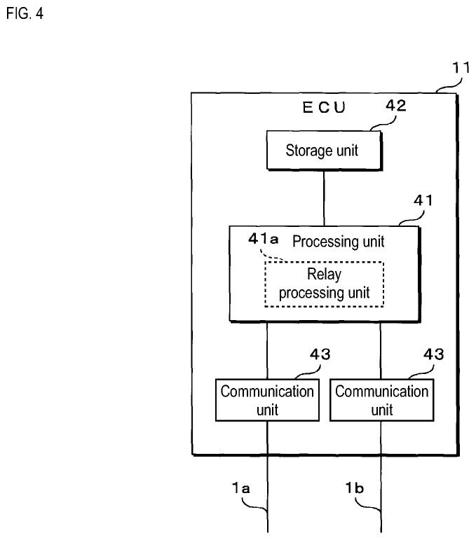

FIG. 4 is a block diagram showing the configuration of the ECU 11 according to the present embodiment. In FIG. 4, functional blocks related to communication of the ECU 11 are extracted and illustrated, and functional blocks related to the control of the vehicle 1 are omitted. The ECU 11 according to the present embodiment includes a processing unit 41, a storage unit 42, and two communication units 43. The processing unit 41 is configured using an arithmetic processing unit such as a CPU and an MPU, and performs various kinds of processing such as communication processing and control processing by reading out and executing the program stored in the storage unit 42. The storage unit 42 is configured using a non-volatile memory element such as a flash memory or an EEPROM (Electrically Erasable Programmable Read Only Memory). The storage unit 42 stores, for example, a program executed by the processing unit 41 and data required for executing the program. The two communication units 43 are respectively connected to the communication lines 1a and 1b, and transmit and receive messages according to the CAN communication protocol via the connected communication lines 1a and 1b.

Also, the processing unit 41 of the ECU 11 according to the present embodiment executes the program stored in the storage unit 42, whereby the relay processing unit 41a is realized as a software functional block. When one communication unit 43 receives a diagnostic message (or a broadcast message), the relay processing unit 41a transmits the diagnostic message through the other communication unit 43, thus relaying the diagnostic message. Note, that the relay processing unit 41a may also be configured to relay the diagnostic message in one direction only, such as relaying a diagnostic message from the communication line 1a to communication line 1b, but not relaying the diagnostic message from the communication line 1b to the communication line 1a.

The configuration of the ECUs 12, 13, 21 to 23, 31 and 32 that are connected to only one of the communication lines 1a to 1c is omitted in the block diagram. These ECUs 12, 13, 21 to 23, 31, and 32 are substantially the same as the configuration having only one communication unit 43 in the configuration of the ECU 11 shown in FIG. 4, and do not perform relay processing of a diagnostic message.

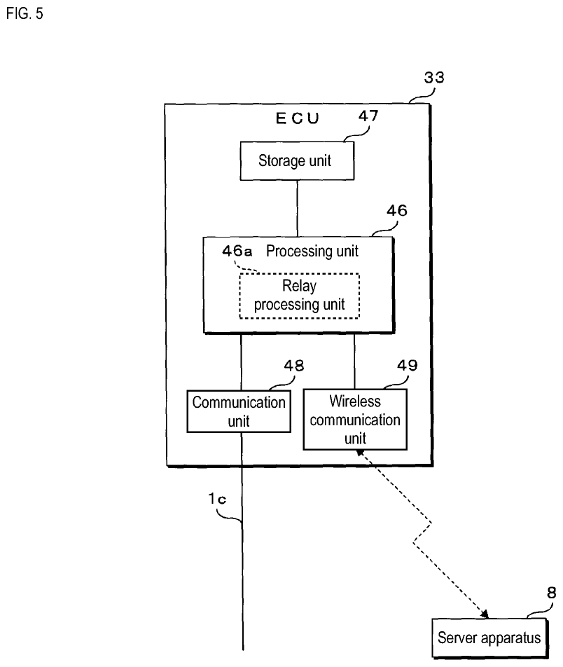

FIG. 5 is a block diagram showing the configuration of the ECU 33 according to the present embodiment. In FIG. 5, functional blocks related to communication of the ECU 33 are extracted and illustrated, and functional blocks related to the control or the like of the vehicle 1 are omitted. The ECU 33 according to the present embodiment includes a processing unit 46, a storage unit 47, a communication unit 48, and a wireless communication unit 49. The processing unit 46 is configured using an arithmetic processing unit such as a CPU and an MPU, and performs various kinds of processing such as communication processing and control processing by reading out and executing the program stored in the storage unit 47. The storage unit 47 is configured using a non-volatile memory element such as a flash memory or an EEPROM. The storage unit 47 stores, for example, a program executed by the processing unit 46 and data required for executing the program. The communication unit 48 transmits and receives messages according to the CAN communication protocol via the communication line 1c.

The wireless communication unit 49 can perform communication with the server apparatus 8 installed outside the vehicle 1 by performing wireless communication using, for example, a mobile telephone communication network, a wireless LAN, or the like. The wireless communication unit 49 performs wireless transmission of messages by outputting signals obtained by modulating transmission messages supplied from the processing unit 46 from an antenna (not shown). Further, the wireless communication unit 49 provides received messages obtained by demodulating signals received by the antenna to the processing unit 46.

Also, the processing unit 46 of the ECU 33 according to the present embodiment executes the program stored in the storage unit 47, whereby the relay processing unit 46a is realized as a software functional block. The relay processing unit 46a performs processing of relaying messages between the wired communication in the vehicle 1 and the wireless communication with the server apparatus 8. In the present embodiment, the relay processing unit 46a relays a diagnostic message by transmitting the diagnostic message from the server apparatus 8 received by the wireless communication unit 49 to the communication line 1c by the communication unit 48. Also, the relay processing unit 46a transmits the messages received from each of the ECUs 11 to 13, 21 to 23, 31, and 32 in the vehicle 1 to the server apparatus 8 by the wireless communication unit 49 in response to the diagnostic message. Note, that because the communication protocol is different between the wired communication in the vehicle 1 and the wireless communication with the server apparatus 8, the relay processing unit 46a performs processing of converting the format of the message to be relayed.

### Message Relay and Discard by Gateway

As mentioned above, in the on-board communication system according to the present embodiment, the gateway 5 determines whether to relay or discard the diagnostic message in order to prevent looping of the diagnostic message. The details of the determination process by the gateway 5 will be described below. Note, that in the following, the case of determining whether to relay or discard the diagnostic message transmitted by the diagnostic apparatus 7 will be described. The description of the determination of the diagnostic message transmitted by the server apparatus 8 will be omitted.

In the on-board communication system according to the present embodiment, because communication is performed according to the CAN communication protocol, a message (a data frame) to be transmitted and received includes an arbitration field, a control field, a data field, a CRC (Cyclic Redundancy Check) field, an ACK field, and the like. The control field of the message includes a CAN-ID indicating the type of the message. In the present embodiment, the diagnostic message transmitted by the diagnostic apparatus 7 (the diagnostic message transmitted by the server apparatus 8 and relayed by the ECU 33) has the same configuration. Note, that the data field of the diagnostic message includes a service ID indicating the type of diagnostic processing and the like.

The discard condition determination unit 51a of the gateway 5 determines whether the diagnostic messages are the same or different, based on the CAN-IDs and the service IDs included in the diagnostic messages. That is to say, when there are two diagnostic messages, the discard condition determination unit 51a determines that the two diagnostic messages are the same if both the CAN-ID and the service ID match, and determines that the two diagnostic messages are different if at least one of the CAN-ID and the service ID does not match.

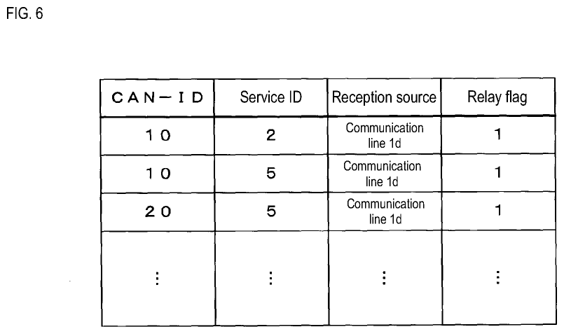

When relaying a diagnostic message, the relay processing unit 51b of the gateway 5 stores information on the diagnostic message as the relay ID information 52a in the storage unit 52, and sets the relay flag 52b. FIG. 6 is a schematic view showing an example of the relay ID information 52a and the relay flags 52b stored in the storage unit 52. In the relay ID information 52a of the storage unit 52, the CAN-ID and the service ID included in the relayed diagnostic message are stored in association with the information on the reception source of the diagnostic message. The information on the reception source included in the relay ID information 52a is information for identifying the communication lines 1a to 1b that have received the relayed diagnostic message (note, that the information does not have to be information for identifying the communication lines 1a to 1d, but may also be information for identifying the communication unit 53).

The relay flag 52b stored in the storage unit 52 is set to either “0” or “1”. For each diagnostic message in which the information is stored in the relay ID information 52a, the relay flag 52b is set to “1” for a predetermined time (for example, 100 milliseconds to several seconds) after the relay is performed, and is set to “0” after the predetermined time has elapsed. The predetermined time at this time is measured by the timer unit 51c.

When the discard condition determination unit 51a of the gateway 5 receives a diagnostic message through one of the communication lines 1a to 1d, the discard condition determination unit 51a compares the received diagnostic message with the relayed diagnostic message in which the relay ID information 52a is stored in the storage unit 52, and determines whether the predetermined discard condition is satisfied. In the present embodiment, the discard condition is that all the following three conditions are satisfied:

Both the CAN-IDs and the service IDs match each other.

The reception sources are different.

The relay flag is “1”.

The discard condition determination unit 51a determines that the discard condition is satisfied if all the above three conditions are satisfied, and determines that the discard condition is not satisfied if one or more of the above three conditions is not satisfied. The condition that “the CAN-ID and the service ID match each other” included in the discard condition is a condition for determining that the diagnostic messages are the same as mentioned above. Even if diagnostic messages have the same CAN-ID and the same service ID, they may be valid diagnostic messages from the diagnostic apparatus 7, for example, the retransmission of the same diagnostic message. Accordingly, the condition that “the reception sources are different” is determined as the discard condition in order to prevent such a diagnostic message from being discarded. The condition that “the relay flag is “1”” is determined as the discard condition in order to prevent a diagnostic message having the same content as a diagnostic message whose information is registered in the relay ID information 52a from not being relayed for a long time period.

The relay processing unit 51b of the gateway 5 transmits the diagnostic message for which it has been determined by the discard condition determination unit 51a that the discard condition is not satisfied to the communication lines 1a to 1d other than the reception source of the diagnostic message, to relay the diagnostic message. The relay processing unit 51b discards the diagnostic message for which it has been determined by the discard condition determination unit 51a that the discard condition is satisfied, without transmitting the diagnostic message to the other communication lines 1a to 1d. To discard the diagnostic message, it is merely required not to relay the diagnostic message, and it is not necessarily required that the diagnostic message be deleted from the memory, buffer or the like.

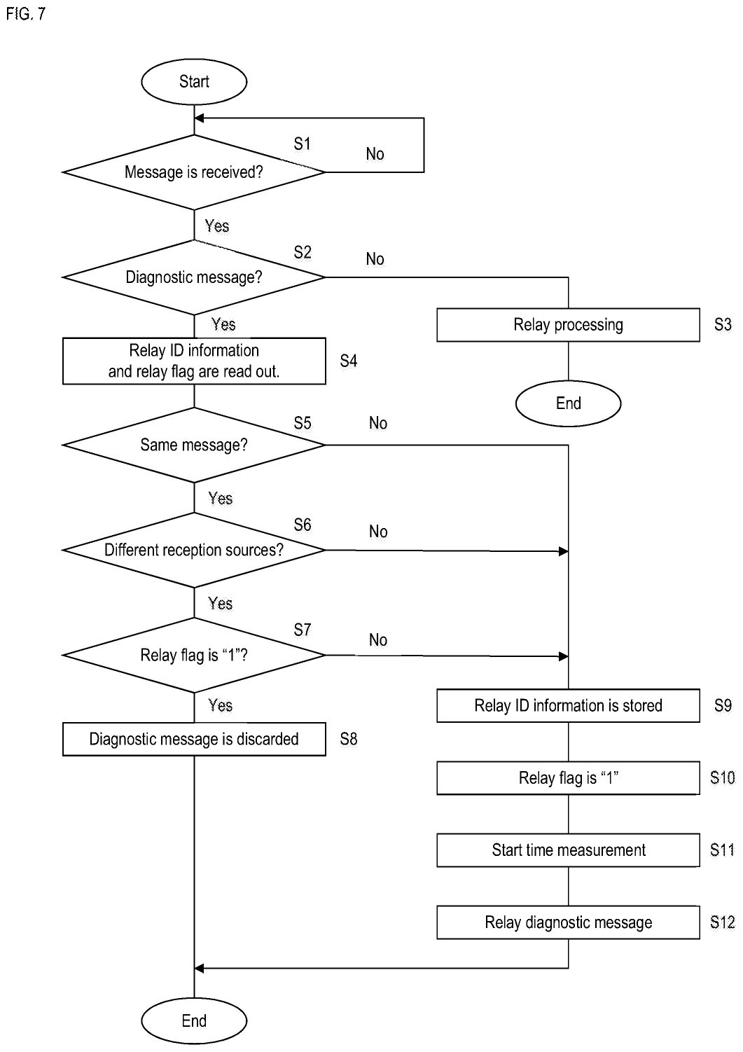

FIG. 7 is a flowchart showing a procedure of the processing of relaying or discarding a diagnostic message, which is performed by the gateway 5. The processing unit 51 of the gateway 5 according to the present embodiment determines whether a message has been received by one of the communication units 53 (step S1). If a message has not been received (NO in step S1), the processing unit 51 waits until a message is received. If a message has been received (YES in step S1), the processing unit 51 determines whether the received message is a diagnostic message, based on the CAN-ID and the service ID of the received message (step S2). If the received message is not a diagnostic message (NO in step S2), the relay processing unit 51b of the processing unit 51 performs relay processing by a method suitable for this message (step S3), and ends the processing.

If the received message is a diagnostic message (YES in step S2), the discard condition determination unit 51a of the processing unit 51 reads out the relay ID information 52a and the relay flag 52b stored in the storage unit 52 (step S4). The discard condition determination unit 51a compares the CAN-ID and the service ID included in the received diagnostic message with the CAN-ID and the service ID stored in the relay ID information 52a, and determines whether the received diagnostic message is the same as a diagnostic message relayed previously (step S5).

If it is determined that the received diagnostic message is the same as a previously relayed diagnostic message (YES in step S5), the discard condition determination unit 51a compares the communication lines 1a to 1d that is the reception source of the received diagnostic message with the information of the reception source of the same diagnostic message relayed previously to determine whether the reception sources are different or not (step S6). If it is determined that the reception source of the received diagnostic message is different from the reception source of the previously relayed diagnostic message (YES in step S6), the discard condition determination unit 51a determines whether the value of the relay flag 52b associated with the previously relayed diagnostic message is “1” (step S7). If the relay flag 52b is “1” (YES in step S7), the discard condition determination unit 51a determines that the discard condition is satisfied for the received diagnostic message. Then, the discard condition determination unit 51a discards the diagnostic message (step S8) without relaying it, and ends the processing.

The discard condition determination unit 51a determines that the discard condition is not satisfied, if the received diagnostic message is not the same as the previously relayed diagnostic message (NO in step S5), if it is determined that the reception source of the received diagnostic message is the same as the reception source of the previously relayed diagnostic message (NO in step S6), or if it is determined that the value of the relay flag 52b associated with the previously relayed diagnostic message is “0” (NO in step S7). In those cases, the relay processing unit 51b of the processing unit 51 relays the received diagnostic message.

In the relay process of the diagnostic message, the relay processing unit 51b first stores the information such as the CAN-ID, the service ID, and the reception source of the diagnostic message to be relayed in the storage unit 52 as the relay ID information 52a (step S9). Next, the relay processing unit 51b sets the value of the relay flag 52b corresponding to the stored relay ID information 52a to “1” (step S10), and starts the time measurement by the timer unit 51c (step S11). After that, the relay processing unit 51b relays the diagnostic message to be relayed through the communication lines 1a to 1d different from the communication lines 1a to 1d that received the diagnostic message (step S12), and ends the processing.

### Summary

The on-board communication system according to the present embodiment having the above configuration has a bus network in which a plurality of ECUs 11 to 13, 21 to 23, and 31 to 33 are connected to the same communication lines (CAN buses) 1a to 1c. A plurality of communication lines 1a to 1d provided in the vehicle 1 are connected to the gateway 5, and the gateway 5 relays message transmission and reception between the communication lines 1a to 1d. The plurality of the ECUs 11 to 13, 21 to 23, and 31 to 33 included in the on-board communication system include the ECUs 12, 13, 21 to 23, and 31 to 33 each connected to one of the communication lines 1a to 1c, and the ECU 11 connected to the two communication lines 1a and 1b. If the ECU 11 receives a diagnostic message (or a broadcast message) through one of the communication lines 1a and 1b, the ECU 11 relays the diagnostic message through the other communication line 1a or 1b.

If the gateway 5 to which the plurality of communication lines 1a to 1d are connected receives a diagnostic message through one of the communication lines 1a to 1d, the gateway 5 determines whether the diagnostic message satisfies a predetermined discard condition. The gateway 5 discards the received diagnostic message without relaying it if it is determined that the discard condition is satisfied, and relays the diagnostic message if it is determined that the discard condition is not satisfied. In this manner, the ECU 11 may simply relay a diagnostic message without determining the discard condition, and the gateway 5 can prevent looping of the diagnostic message.

The gateway 5 compares the CAN-ID and the service ID included in previously relayed diagnostic messages with the CAN-ID and the service ID included in the newly received diagnostic message. Then, the gateway 5 determines that the CAN-ID and the service ID of two messages match as one of the discard conditions. As a result, the gateway 5 can be prevented from relaying again diagnostic messages that are likely to be the same as relayed previously diagnostic messages.

The gateway 5 determines that the communication lines 1a to 1d receiving the previously relayed diagnostic messages and the communication lines 1a to 1d receiving the diagnostic message received this time are different as one of the discard conditions. If a diagnostic message with the same CAN-ID and the service ID is received by another communication line 1a to 1d, this diagnostic message is likely to be a diagnostic message cyclically relayed by the ECU 11. Accordingly, it is possible to prevent relaying such a diagnostic message again.

Also, in the present embodiment, the message for which the gateway 5 determines whether the discard condition is satisfied is a broadcast message transmitted simultaneously to all the ECUs 11 to 13, 21 to 23, and 31 to 33 and/or a diagnostic message related to the diagnosis of the vehicle 1. Such a message is highly likely to be relayed by the ECU 11 to which the plurality of communication lines 1a and 1b are connected, and is a message that may be relayed repeatedly by the gateway 5 and the ECU 11. Therefore, by setting these messages as the messages for which it is determined whether the discard condition is satisfied, it is possible to prevent the occurrence of message loops.

Further, in the on-board communication system according to the present embodiment, the plurality of communication lines 1a to 1d connected to the gateway 5 include the communication line 1d connected to the connector 6 for attaching and detaching the diagnostic apparatus 7 of the vehicle 1, and the diagnostic apparatus 7 connected to the connector 6 transmits a diagnostic message. Alternatively, the plurality of ECUs 11 to 13, 21 to 23, and 31 to 33 included in the on-board communication system include the ECU 33 that has a function of performing wireless communication with the server apparatus 8 that diagnoses the vehicle 1. The ECU 33 transmits the diagnostic message received from the server apparatus 8 to the communication line 1c in the vehicle 1. The gateway 5 can prevent the diagnostic message transmitted from the external diagnostic apparatus 7 or the server apparatus 8 from being repeatedly relayed in the network in the vehicle 1.

In the present embodiment, the messages for which the gateway 5 determines whether the discard condition is satisfied are diagnostic messages (or broadcast messages), but the messages are not limited to this. The messages for which the gateway 5 determines whether the discard condition may also be any message as long as the message may be relayed by the ECU 11 to which the plurality of communication lines 1a to 1b are connected. Also, although it is configured to determine whether or not the diagnostic messages are the same depending on whether or not the CAN-ID and the service ID of the diagnostic message match each other, the configuration is not limited to this. Only one of the CAN-ID and the service ID may also be used to determine whether the diagnostic messages are the same.

Although the on-board communication system includes one ECU 11 connected to the two communication lines 1a and 1b, the configuration is not limited to this. Three or more ECUs connected to the two communication lines may also be included. Further, an ECU connected to three or more communication lines may also be included. Moreover, although the diagnostic apparatus 7 and the server apparatus 8 were mentioned as an apparatus that transmits a diagnostic message, the apparatus is not limited to this. Any other apparatus may also be configured to transmit a diagnostic message. The diagnostic apparatus 7 and the ECU 33 may also be configured to perform wireless communication.

1. An on-board communication system comprising:
an on-board relay apparatus to which a plurality of bus communication lines mounted in a vehicle are connected, and that is configured to relay message transmission and reception between the plurality of communication lines;
a plurality of first on-board communication apparatuses each connected to exactly one of the plurality of communication lines; and
a second on-board communication apparatus connected to at least two of the plurality of communication lines,
wherein the second on-board communication apparatus includes a specific message relay processing unit configured to, if a specific message is received through one of the connected communication lines, perform a processing of transmitting the specific message through another one of the communication lines,
the on-board relay apparatus includes:
a determination unit configured to determine whether the specific message received through one of the connected communication lines satisfies a predetermined discard condition; and
a specific message relay processing unit configured to not relay the specific message if the determination unit determines that the specific message satisfies the discard condition, and to perform a processing of transmitting the specific message through another one of the communication lines if the determination unit determines that the specific message does not satisfy the discard condition.

2. The on-board communication system according to claim 1, wherein
the determination unit of the on-board relay apparatus is configured to determine whether identification information included in a specific message previously transmitted by the specific message relay processing unit of the on-board relay apparatus matches identification information included in the specific message received through one of the communication lines, and
the specific message relay processing unit does not relay the specific massage if the determination unit determines that the identification information matches.

3. The on-board communication system according to claim 2, wherein
the determination unit of the on-board relay apparatus is configured to:
determine whether identification information included in a specific message previously transmitted by the specific message relay processing unit of the on-board relay apparatus matches identification information included in a specific message received through one of the communication lines; and
determine whether the communication line through which the previous specific message whose identification information matches was received and the communication line through which the current specific message is received are different from each other, and
the specific message relay processing unit is configured to not relay the specific message if the determination unit determines that the identification information matches, and both communication lines are different from each other.

4. The on-board communication system according to claim 2, wherein
the on-board relay apparatus includes:
a storage unit configured to store identification information included in the relayed specific message; and
a timer unit configured to measure an elapsed time from transmission of the specific message for each piece of identification information stored in the storage unit, and
the determination unit of the on-board relay apparatus determines whether the discard condition is satisfied for any specific message including the identification information whose elapsed time measured by the timer unit is within a predetermined time.

5. The on-board communication system according to claim 1, wherein
the plurality of communication lines include a communication line to which a connector for attaching and detaching a diagnostic apparatus of the vehicle is connected, and
the diagnostic apparatus connected to the connector transmits the specific message to the communication line.

6. The on-board communication system according to claim 1, wherein
the plurality of first on-board communication apparatuses includes a wireless communication apparatus configured to perform wireless communication with the diagnostic apparatus of the vehicle, and
the wireless communication apparatus transmits the specific message that is received from the diagnostic apparatus by wireless communication to the communication line of the vehicle.

7. An on-board relay apparatus to which a plurality of bus communication lines mounted in a vehicle are connectable, and that is configured to relay message transmission and reception between the plurality of communication lines, the on-board relay apparatus comprising:
a determination unit configured to determine whether a specific message received through one of the connected communication lines satisfies a predetermined discard condition; and
a specific message relay processing unit configured to not relay the specific message if the determination unit determines that the specific message satisfies the discard condition, and to perform a processing of transmitting the specific message through another one of the communication lines if the determination unit determines that the specific message does not satisfy the discard condition.

8. A message relay method in which an on-board relay apparatus to which a plurality of bus communication lines mounted in a vehicle are connected relays message transmission and reception between the plurality of communication lines, the message relay method comprising the steps of:
determining whether a specific message received through one of the connected communication lines satisfies a predetermined discard condition;
not relaying the specific message if it is determined that the specific message satisfies the discard condition; and
transmitting the specific message through another one of the communication lines if it is determined that the specific message does not satisfy the discard condition.

9. The on-board communication system according to claim 3, wherein
the on-board relay apparatus includes:
a storage unit configured to store identification information included in the relayed specific message; and
a timer unit configured to measure an elapsed time from transmission of the specific message for each piece of identification information stored in the storage unit, and
the determination unit of the on-board relay apparatus determines whether the discard condition is satisfied for any specific message including the identification information whose elapsed time measured by the timer unit is within a predetermined time.

10. The on-board communication system according to claim 2, wherein
the plurality of communication lines include a communication line to which a connector for attaching and detaching a diagnostic apparatus of the vehicle is connected, and
the diagnostic apparatus connected to the connector transmits the specific message to the communication line.

11. The on-board communication system according to claim 3, wherein
the plurality of communication lines include a communication line to which a connector for attaching and detaching a diagnostic apparatus of the vehicle is connected, and
the diagnostic apparatus connected to the connector transmits the specific message to the communication line.

12. The on-board communication system according to claim 4, wherein
the plurality of communication lines include a communication line to which a connector for attaching and detaching a diagnostic apparatus of the vehicle is connected, and
the diagnostic apparatus connected to the connector transmits the specific message to the communication line.

13. The on-board communication system according to claim 2, wherein
the plurality of first on-board communication apparatuses includes a wireless communication apparatus configured to perform wireless communication with the diagnostic apparatus of the vehicle, and
the wireless communication apparatus transmits the specific message that is received from the diagnostic apparatus by wireless communication to the communication line of the vehicle.

14. The on-board communication system according to claim 3, wherein
the plurality of first on-board communication apparatuses includes a wireless communication apparatus configured to perform wireless communication with the diagnostic apparatus of the vehicle, and
the wireless communication apparatus transmits the specific message that is received from the diagnostic apparatus by wireless communication to the communication line of the vehicle.

15. The on-board communication system according to claim 4, wherein
the plurality of first on-board communication apparatuses includes a wireless communication apparatus configured to perform wireless communication with the diagnostic apparatus of the vehicle, and
the wireless communication apparatus transmits the specific message that is received from the diagnostic apparatus by wireless communication to the communication line of the vehicle.

16. The on-board communication system according to claim 5, wherein
the plurality of first on-board communication apparatuses includes a wireless communication apparatus configured to perform wireless communication with the diagnostic apparatus of the vehicle, and
the wireless communication apparatus transmits the specific message that is received from the diagnostic apparatus by wireless communication to the communication line of the vehicle.
